(19) United States
(12) Patent Application Publication
(10) Pub. No.: US 2025/0155706 A1
(43) Pub. Date: May 15, 2025

(54) Remote Phosphor To Improve Zone Uniformity In Local Dimming HUD

(71) Applicant: Panasonic Automotive Systems Company of America, Division of Panasonic Corporation of North America, Peachtree City, GA (US)

(72) Inventor: MARC LATA, ATLANTA, GA (US)

(21) Appl. No.: 18/946,007

(22) Filed: Nov. 13, 2024

Related U.S. Application Data
(60) Provisional application No. 63/599,172, filed on Nov. 15, 2023.

(51) Int. Cl. G02B 27/01; B60K 35/234

(52) U.S. Cl. CPC G02B 27/0101; B60K 35/234; G02B 2027/0118

(57) ABSTRACT

A head up display arrangement for a motor vehicle includes a picture generation unit having a plurality of light emitters each emitting blue light. A plurality of collimating optics receive the blue light from the light emitters and collimate the received blue light. At least one phosphor element receives the collimated blue light and converts the collimated blue light to diffuse white light. A liquid crystal display receives the diffuse white light and emits a light field dependent upon the diffuse white light. At least one mirror reflects the light field emitted by the liquid crystal display such that the reflected light field is again reflected by a windshield of the motor vehicle so as to be visible by a human driver of the motor vehicle as a virtual image.

### CROSS-REFERENCED TO RELATED APPLICATIONS

This application claims benefit of U.S. Provisional Application No. 63/599,172, filed on Nov. 15, 2023, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Some HUDs perform local dimming, which increases contrast by dimming the background behind dim or dark areas of the virtual image, thereby increasing the contrast between those dark areas and bright elements that are in the virtual image. One critical metric for a local dimming heads-up display is the uniformity. Due to the nature of their design, local dimming HUDs are prone to having “textures” in their illumination distribution.

In order to achieve a local dimming backlight, the light from individual light emitting diodes (LEDs) must be collimated before being projected onto a liquid crystal display (LCD) screen. For typical LCD backlight systems, white LEDs are utilized to achieve the correct color balance on the display. White light LEDs are produced by coating a blue LED with a phosphor that will absorb and re-emit light in a continuous spectrum.

When white light passes through an optical element, the different wavelengths present refract at slightly different angles as dictated by the dispersion relationship of light in that material, or the change in the index of refraction as a function of the wavelength. FIG. 1 illustrates a dispersion curve for polycarbonate. This tendency is commonly known as “chromatic aberration.” In the application of a local dimming PGU, this leads to a red fringe on the projected zone, due to the collimating power of the lens being slightly weaker for red light as compared to blue light. This chromatic aberration leads to an uneven zone brightness, especially when passing through an LCD, which contains RGB color filters and amplifies the color differences.

FIG. 2 is a schematic side view of an LED and collimating optic of the prior art illustrating chromatic aberration and the resulting red fringe in zone. At the top of FIG. 2 is a top view of the collimated light with red fringe produced by the LED and collimating optic.

### SUMMARY

The present invention may provide a local dimming heads-up display (HUD) picture generation unit (PGU) that implements a “remote phosphor” arrangement to avoid chromatic aberration during the collimation of the zones. The invention may make use of a “remote phosphor” for converting the blue LED light to white light. That is, the phosphor can be removed from a location before the collimating optics so that only blue light is collimated uniformly. A phosphor film may be applied after the collimation is performed that converts the collimated blue beams to the desired white light. This avoids any aberrations that result from the dispersive properties of the lens and results in a more uniform and homogenous illumination spot on the LCD. The phosphorous film may be attached to a diffusive substrate or placed before the diffuser that is already included in LCD stack-up.

In one embodiment, the invention comprises a head up display arrangement for a motor vehicle including a picture generation unit having a plurality of light emitters each emitting blue light. A plurality of collimating optics receive the blue light from the light emitters and collimate the received blue light. At least one phosphor element receives the collimated blue light and converts the collimated blue light to diffuse white light. A liquid crystal display receives the diffuse white light and emits a light field dependent upon the diffuse white light. At least one mirror reflects the light field emitted by the liquid crystal display such that the reflected light field is again reflected by a windshield of the motor vehicle so as to be visible by a human driver of the motor vehicle as a virtual image.

In another embodiment, the invention comprises a method of operating a head up display for a motor vehicle, including emitting blue light and collimating the emitted blue light. The collimated blue light is converted to diffuse white light. The diffuse white light is received, and a light field is emitted dependent upon the received diffuse white light. The light field is reflected such that the reflected light field is again reflected by a windshield of the motor vehicle so as to be visible by a human driver of the motor vehicle as a virtual image.

In yet another embodiment, the invention comprises a picture generation unit for a head up display of a motor vehicle. The picture generation unit includes a plurality of light emitters each emitting blue light. A plurality of collimating optics receive the blue light from the light emitters and collimate the received blue light. At least one phosphor film receives the collimated blue light and converts the collimated blue light to diffuse white light. A liquid crystal display receives the collimated white light and emits a light field dependent upon the diffuse white light.

An advantage of the invention is that it resolves a problem inherent in the collimation optics of a local dimming backlight that contributes to the texture effect of a local dimming HUD.

### BRIEF DESCRIPTION OF THE DRAWINGS

A better understanding of the present invention will be had upon reference to the following description in conjunction with the accompanying drawings.

FIG. 1 is a prior art plot of a dispersion curve for polycarbonate.

FIG. 2 is a schematic view of an LED and collimating optic of the prior art.

FIG. 3 is a schematic view of one embodiment of an LED, collimating optic and remote phosphor element of a head up display arrangement of the present invention.

FIG. 4 is a set of schematic diagrams of other remote phosphor applications.

FIG. 5 is a perspective view of a roll of phosphor sheet that is suitable for making the remote phosphor element of the head up display arrangement FIG. 3.

FIG. 6a is a perspective view of an LED with phosphor of the prior art.

FIG. 6b is a perspective view of an LED without phosphor suitable for use as the LED of FIG. 3.

FIG. 7 is a schematic diagram of one embodiment of a head up display arrangement of the present invention including the LED, collimating optic and remote phosphor element of FIG. 3.

FIG. 8 is a flow chart of one embodiment of a method of the present invention for operating a head up display for a motor vehicle.

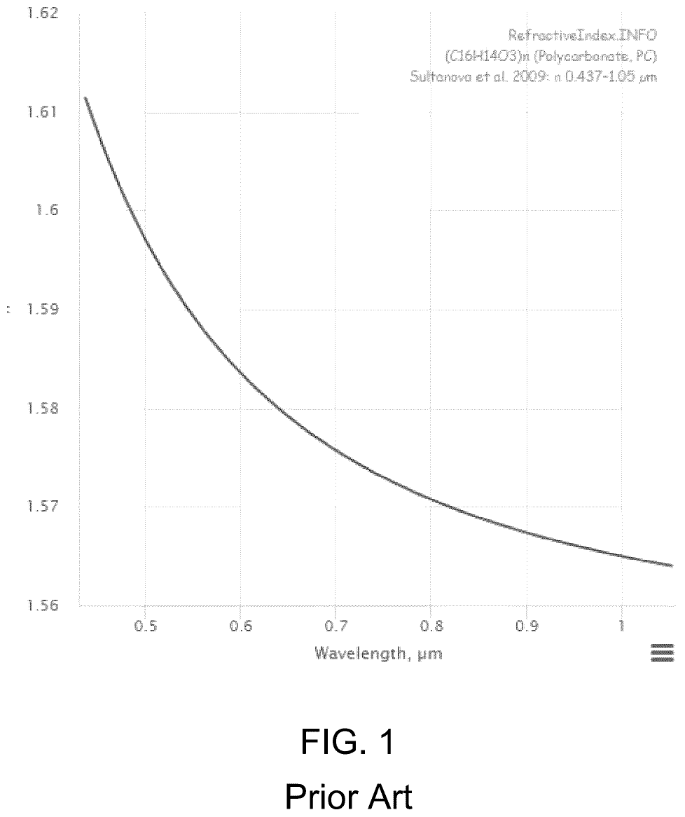

### DETAILED DESCRIPTION OF THE PREFERRED EMBODIMENTS

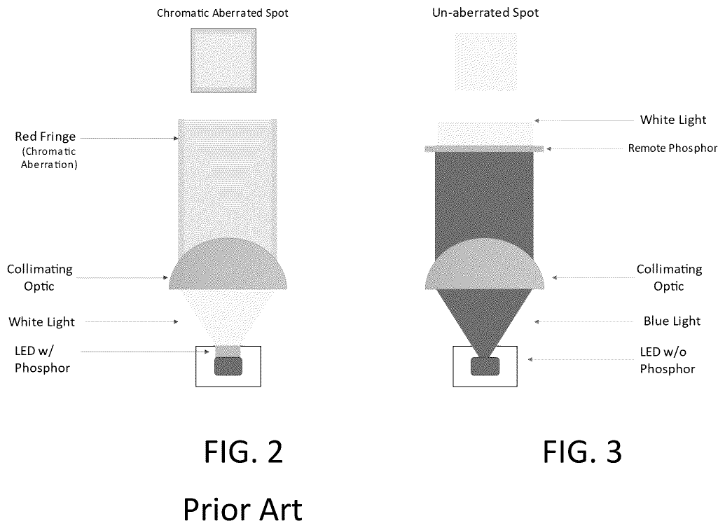

FIG. 3 illustrates one embodiment of an LED, collimating optic and remote phosphor element of a head up display arrangement of the present invention. In contrast to the prior art LED of FIG. 2, the LED is without phosphor. As a result, blue light from the LED is collimated by the optics, which is shown as a lens. A remote phosphor element downstream of the optics passes only the desired white light therethrough. The remote phosphor element may be planar-shaped and formed mainly of phosphor. The remote phosphor element may be formed of a flexible phosphor film. At the top of FIG. 3 is a top view of the un-aberrated white light produced by the LED, collimating optic and remote phosphor element.

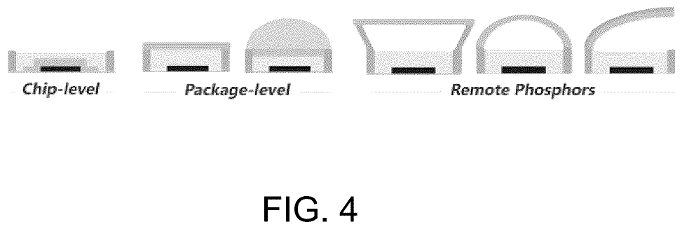

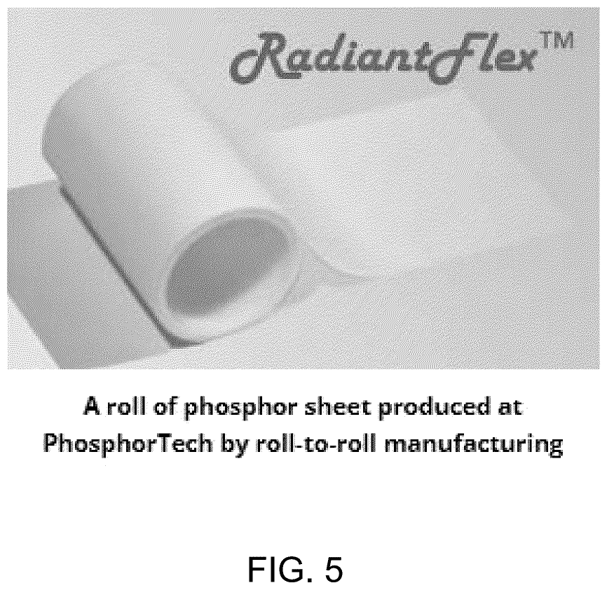

FIG. 4 illustrates other remote phosphor applications within the scope of the invention. FIG. 5 illustrates a roll of phosphor sheet or phosphor flexible film that is suitable for making the remote phosphor element of FIG. 3. This phosphor roll product is marketed as RadiantFlex™ by PhosphorTech Corporation of Kennesaw, Georgia.

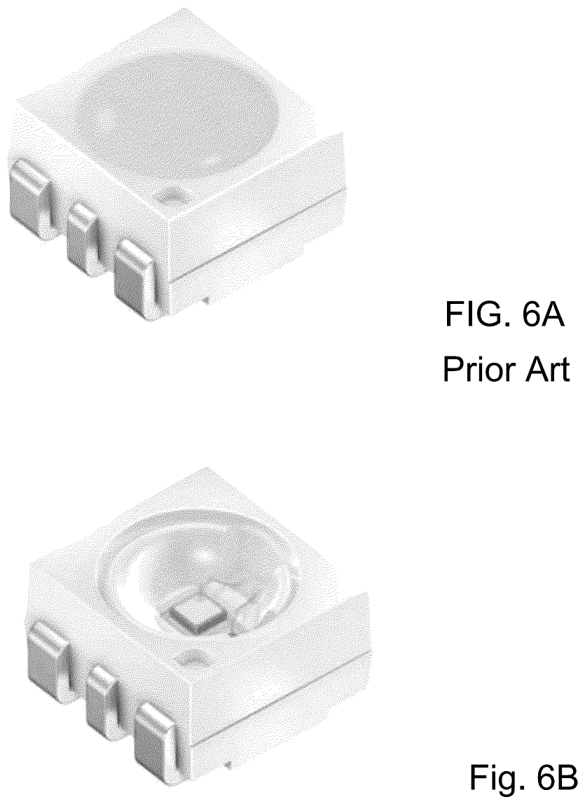

FIG. 6a illustrates an LED with phosphor coating of the prior art. FIG. 6b illustrates an LED without phosphor suitable for use the LED of FIG. 3.

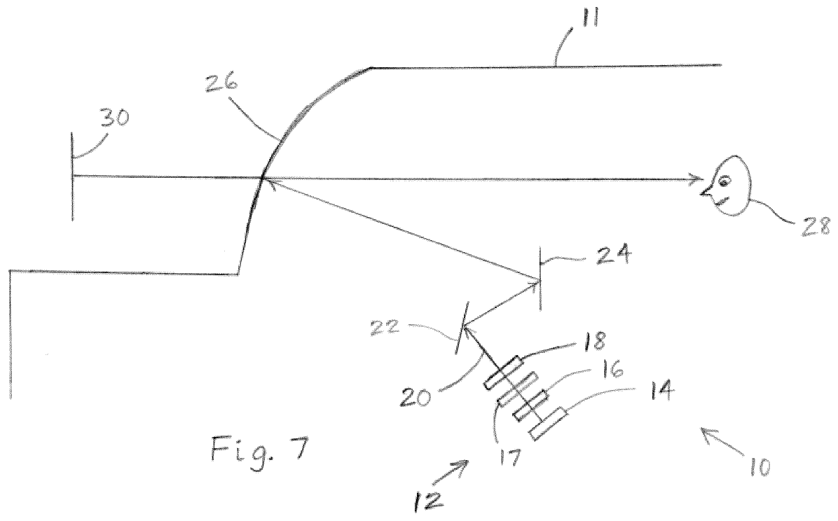

FIG. 7 illustrates one embodiment of a head up display arrangement 10 of the present invention including the LED, collimating optic and remote phosphor element of FIG. 3. Head up display arrangement 10 may be installed in a motor vehicle 11. A picture generation unit 12 includes LEDs 14, collimating optics 16, remote phosphor elements 17 and LCD 18.

During use, a light field 20 (which is shown in FIG. 7 as a single ray for ease of illustration) from picture generation unit 12 may be reflected by mirrors 22, 24 and windshield 26 such that light field 20 is visible to a human driver 28 as a virtual image 30.

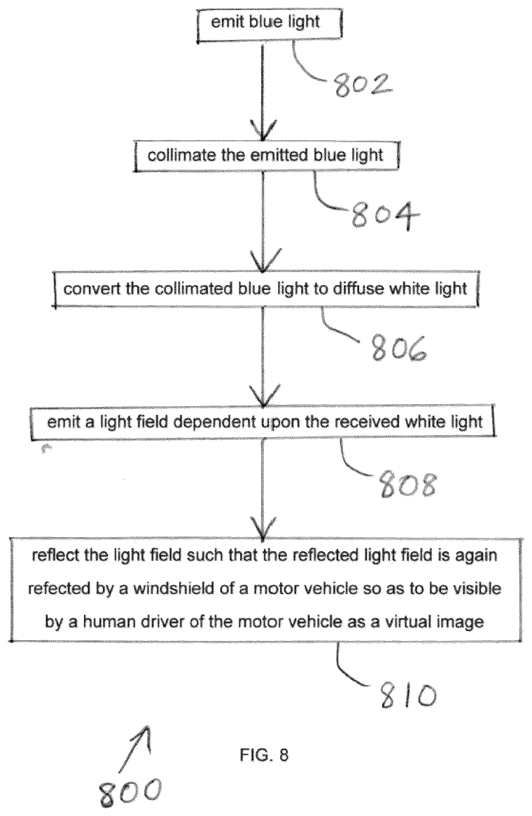

FIG. 8 illustrates one embodiment of a method 800 of the present invention for operating a head up display for a motor vehicle. In a first step 802, blue light is emitted. For example, blue light may be emitted by the LED without phosphor of FIG. 3.

Next, in step 804, the emitted blue light is collimated. For example, the collimating optic of FIG. 3 may collimate the blue light emitted by the LED.

In a next step 806, the collimated blue light is converted to diffuse white light. For example, when the blue collimated light passes through the remote phosphor, it comes out of the remote phosphor as diffuse white light.

In step 808, a light field is emitted dependent upon the received white light. For example, LCD 18 may receive the diffuse white from remote phosphor elements 17. LCD 18 may emit a light field 20 that is dependent upon the white light received from remote phosphor elements 17.

In a final step 810, the light field is reflected such that the reflected light field is again reflected by a windshield of the motor vehicle so as to be visible by a human driver of the motor vehicle as a virtual image. For example, light field 20 may be reflected by mirrors 22, 24 such that reflected light field 20 is again reflected by windshield 26 of motor vehicle 11 so as to be visible by human driver 28 of motor vehicle 11 as virtual image 30.

The present invention has been described herein with reference to specific embodiments. However, it is to be understood that other embodiments are possible within the scope of the invention. For example, mirrors may be used instead of lenses to collimate LEDs. In another possible embodiment, achromatic lenses may be used. In yet another embodiment different remote phosphor applications or positions may be employed.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
a picture generation unit including:
a plurality of light emitters each configured to emit blue light;
a plurality of collimating optics positioned and configured to receive the blue light from the light emitters and collimate the received blue light;
at least one phosphor element positioned and configured to receive the collimated blue light and convert the collimated blue light to diffuse white light;
a liquid crystal display positioned and configured to receive the diffuse white light and emit a light field dependent upon the diffuse white light; and
at least one mirror positioned and configured to reflect the light field emitted by the liquid crystal display such that the reflected light field is again reflected by a windshield of the motor vehicle so as to be visible by a human driver of the motor vehicle as a virtual image.

2. The head up display arrangement of claim 1 wherein each of the light emitters comprises a light emitting diode.

3. The head up display arrangement of claim 1 wherein each of the collimating optics comprises a lens.

4. The head up display arrangement of claim 1 wherein the at least one phosphor element comprises a phosphor sheet.

5. The head up display arrangement of claim 4 wherein the phosphor sheet is oriented substantially perpendicular to the collimated blue light.

6. The head up display arrangement of claim 1 wherein the at least one phosphor element comprises a flexible phosphor film.

7. The head up display arrangement of claim 6 wherein the flexible phosphor film is oriented substantially perpendicular to the collimated blue light.

8. A method of operating a head up display for a motor vehicle, the method comprising:
emitting blue light;
collimating the emitted blue light;
converting the collimated blue light to diffuse white light;
receiving the diffuse white light;
emitting a light field dependent upon the received diffuse white light; and
reflecting the light field such that the reflected light field is again reflected by a windshield of the motor vehicle so as to be visible by a human driver of the motor vehicle as a virtual image.

9. The method of claim 8 wherein the emitting step is performed by a light emitting diode.

10. The method of claim 8 wherein the collimating step is performed by a lens.

11. The method of claim 8 wherein the converting step is performed by a phosphor sheet.

12. The method of claim 11 wherein the phosphor sheet is oriented substantially perpendicular to the collimated blue light.

13. The method of claim 8 wherein the converting step is performed by a flexible phosphor film.

14. The method of claim 13 wherein the flexible phosphor film is oriented substantially perpendicular to the collimated blue light.

15. A picture generation unit for a head up display of a motor vehicle, the picture generation unit comprising:
a plurality of light emitters each configured to emit blue light;
a plurality of collimating optics positioned and configured to receive the blue light from the light emitters and collimate the received blue light;
at least one phosphor film positioned and configured to receive the collimated blue light and convert the collimated blue light to diffuse white light; and
a liquid crystal display positioned and configured to receive the diffuse white light and emit a light field dependent upon the diffuse white light.

16. The picture generation unit of claim 15 wherein each of the light emitters comprises a light emitting diode.

17. The picture generation unit of claim 15 wherein each of the collimating optics comprises a lens.

18. The picture generation unit of claim 15 wherein the at least one phosphor film is flexible.

19. The picture generation unit of claim 18 wherein the flexible phosphor film is oriented substantially perpendicular to the collimated blue light.

20. The picture generation unit of claim 15 wherein the at least one phosphor film is oriented substantially perpendicular to the collimated blue light.
